(19) United States
(12) Patent Application Publication
(10) Pub. No.: US 2024/0380872 A1
(43) Pub. Date: Nov. 14, 2024

(54) VIDEO COMMUNICATION METHOD AND SYSTEM BASED ON THREE-DIMENSIONAL DISPLAYING

(71) Applicants: Beijing BOE Display Technology Co., Ltd., Beijing (CN); BOE Technology Group Co., Ltd., Beijing (CN)

(72) Inventors: Zhifu LI, Beijing (CN); Lili CHEN, Beijing (CN); Jinghua MIAO, Beijing (CN); Wenyu LI, Beijing (CN)

(21) Appl. No.: 18/691,899

(22) PCT Filed: Jul. 7, 2023
(86) PCT No.: PCT/CN2023/106355

§ 371 Date: Mar. 14, 2024

(30) Foreign Application Priority Data
Jul. 29, 2022 (CN) 202210911037.4

(51) Int. Cl. H04N 13/279; G06T 5/70; G06T 9/00; G06T 17/00; G06V 40/16; H04N 13/302

(52) U.S. Cl. CPC H04N 13/279; G06T 5/70; G06T 9/00; G06T 17/00; G06V 40/161; G06V 40/171; H04N 13/302

(57) ABSTRACT

A video communication method and system based on three-dimensional displaying. The method comprises: a first device obtains information of a first view point of first user at a first moment and sends the information to a second device; the second device photographs first images of second user by m cameras, determines first high/low definition regions of first images according to first view point, separately encodes first high/low definition regions sends encoded data to first device; first device decodes to obtain m second images, determines second high/low definition regions of second images according to an offset of current view point relative to first view point; first and second three-dimensional models are obtained by respectively calculating and rendering second high/low definition regions with first and second neural networks, the two models are combined to obtain third three-dimensional model, target display position of which on display screen is determined and displaying is performed.

### CROSS-REFERENCE TO RELATED APLICATIONS

The present application is a U.S. National Phase Entry of International Application No. PCT/CN2023/106355 having an international filing date of Jul. 7, 2023, which claims priority to Chinese patent application No. 202210911037.4, filed to the CNIPA on Jul. 29, 2022, which are hereby incorporated herein by reference in their entireties.

### TECHNICAL FIELD

The embodiments of the present application relate to the field of image processing, in particular to a video communication method and system based on three-dimensional display.

### BACKGROUND

3D display has always been recognized as the ultimate dream of display technology development. After years of technological development, there are two stereoscopic display technology systems in the market: glasses and naked-eye. Among them, naked-eye 3D display technology is also known as autostereoscopic display technology, which is a future development trend of 3D display technology.

The display content of a traditional naked-eye 3D display device is a playback content source made in advance. If naked-eye 3D display devices are intended to be applied to real-time communication, real 3D scenes need to be made. In this case, multiple cameras are used to take images synchronously from multiple angles, and calculation is performed according to these images to generate a 3D model, and then the picture texture is attached on the model for display. Due to the limitation of bandwidth and graphics card capability, it is difficult to meet the real-time requirements, making it difficult for naked eye 3D display devices to be used in real-time communication.

### SUMMARY

The following is a summary of subject matter described herein in detail. This summary is not intended to limit the protection scope of the claims.

An embodiment of the present application provides a video communication method based on three-dimensional display, including:
acquiring, by a first device, information of a first view point of a first user at a first time and sending the information of the first view point to a second device; after the second device receives the information of the first view point, taking, by the second device, first images of a second user through m cameras, determining a first high-definition area and a first low-definition area of each first image according to the information of the first view point, encoding first high-definition areas and first low-definition areas respectively to enable image resolution of the encoded first high-definition areas is higher than that of the encoded first low-definition areas, and sending data of encoded m first images to the first device; wherein, areas around the first view point are the first high-definition areas, and other areas than the first high-definition areas are the first low-definition areas; and m is greater than or equal to 2;
decoding, by the first device, the data of the encoded m first images to obtain m second images, acquiring information of a second view point of the first user at a second time, determining an offset of the second view point relative to the first view point, and determining second high-definition areas and second low-definition areas of the m second images according to the offset; wherein, areas around the second view point are the second high-definition areas, and other areas than the second high-definition areas are the second low-definition areas;
obtaining, by the first device, a first three-dimensional model by calculating and rendering the second high-definition areas of the m second images with a first neural network, obtaining a second three-dimensional model by calculating and rendering the second low-definition areas of the m second images with a second neural network, and splicing the first three-dimensional model and the second three-dimensional model to obtain a third three-dimensional model; wherein complexity of the first neural network is higher than that of the second neural network; and
determining, by the first device, a target display position of the third three-dimensional model on a display screen according to the information of the second view point, and displaying the third three-dimensional model at the target display position;
wherein the first device and the second device are three-dimensional display devices.

An embodiment of the present application provides a video communication system based on three-dimensional display, including a first device and a second device.

The first device is configured to acquire information of a first view point of a first user at a first time and send the information of the first view point to a second device, receive data of encoded m first images sent by the second device, decode the data of the encoded m first images to obtain m second images, acquire information of a second view point of the first user at a second time, determine an offset of the second view point relative to the first view point, and determine second high-definition areas and second low-definition areas of the m second images according to the offset; wherein, areas around the second view point are second high-definition areas, and other areas than the second high-definition areas are second low-definition areas; obtain a first three-dimensional model by calculating and rendering the second high-definition areas of the m second images with a first neural network, obtain a second three-dimensional model by calculating and rendering the second low-definition areas of the m second images with a second neural network, obtain a third three-dimensional model by splicing the first three-dimensional model and the second three-dimensional model, wherein complexity of the first neural network is higher than that of the second neural network; determine a target display position of the third three-dimensional model on a display screen according to the information of the second view point, and display the third three-dimensional model at the target display position.

The second device is configured to take first images of a second user through m cameras after receiving the information of the first view point; determine a first high-definition area and a first low-definition area of each first image according to the information of the first view point; encode the first high-definition areas and the first low-definition areas respectively to enable image resolution of the encoded first high-definition areas is higher than that of the first low-definition areas, and send the data of the encoded m first images to the first device; wherein, areas around the first view point are the first high-definition areas, and other areas than the first high-definition areas are the first low-definition areas; and m is greater than or equal to 2.

Herein the first device and the second device are three-dimensional display devices.

According to the video communication method and system based on three-dimensional display provided by the embodiments of the present application, a first device sends information of a view point of a first user to a second device, and the second device determines high-definition areas (areas around the view point) and low-definition areas of m first images of the second user taken by m cameras according to the information of the view point, encodes the high-definition areas and the low-definition areas in different coding modes such that image resolution of the encoded high-definition areas is higher than that of the encoded low-definition areas. The transmission bandwidth occupied by the encoded images can be saved by partition encoding, and since the areas around the view point are encoded in high definition, the bandwidth is saved without affecting the image definition of the areas concerned by the first user. The second device sends data of the encoded m first images to the first device, the first device decodes the data of the encoded m first images to obtain m second images, and determines an offset of the current view point (second view point) of the first user relative to the previous view point (first view point), determines the high-definition areas and the low-definition areas of the m second images according to the offset, calculates and renders the high-definition areas of the m second images with a first neural network to obtain a first three-dimensional model, calculates and renders the low-definition areas of the m second images with a second neural network to obtain a second three-dimensional model, and splices the first three-dimensional model and the second three-dimensional model to obtain a third three-dimensional model; wherein complexity of the first neural network is higher than that of the second neural network. By three-dimensional modeling of high-definition and low-definition areas using neural networks with different complexities respectively, the computational resources can be saved, and due to the use of the neural network with high complexity for the areas around the view point, the effect of three-dimensional modeling can be guaranteed. The first device determines a target display position of a third three-dimensional model on a display screen according to the information of a current view point, and displays the third three-dimensional model at the target display position. The video communication method and system in the present disclosure can implement real-time three-dimensional scene video communication, and save communication bandwidth and computational resources.

Other aspects of the present disclosure may be comprehended after the drawings and the detailed descriptions are read and understood.

### BRIEF DESCRIPTION OF DRAWINGS

Accompanying drawings are used for providing an understanding for technical solutions of the present application and form a part of the specification, are used for explaining the technical solutions of the present application together with embodiments of the present application, and do not constitute a limitation on the technical solutions of the present application.

FIG. 1 is a flowchart of a video communication method based on three-dimensional display according to an embodiment of the present application.

FIG. 2 is a schematic diagram of distribution of cameras on a display screen according to an embodiment of the present application.

FIG. 3 is a schematic diagram of a second high definition area of a second image according to an embodiment of the present application.

FIG. 4 is a schematic diagram of smoothing (optimization) of a first curve (a second curve) according to an embodiment of the present application.

FIG. 5 is a diagram of a structure of a video communication system based on three-dimensional display according to an embodiment of the present application.

### DETAILED DESCRIPTION

Multiple embodiments are described in the present application. However, the description is exemplary and unrestrictive. Moreover, it is apparent to those of ordinary skills in the art that there may be more embodiments and implementation solutions within the scope of the embodiments described in the present application. Although many possible combinations of features are shown in the accompanying drawings and discussed in specific implementations, many other combinations of the disclosed features are also possible. Unless expressly limited, any feature or element of any embodiment may be used in combination with, or may replace, any other feature or element in any other embodiment.

The present application includes and conceives combinations with features well known to those of ordinary skills in the art. The embodiments, features that have been disclosed in the present application may also be combined with any conventional features to form unique inventive solutions defined by the appended claims. Any feature of any embodiment may also be combined with a feature from another inventive solution, to form another unique inventive solution defined by the appended claims. Therefore, it should be understood that any feature shown and/or discussed in the present application may be implemented independently or in any appropriate combination. Therefore, the embodiments are not to be limited except the limitations by the appended claims and equivalents thereof. Furthermore, various modifications and variations may be made within the protection scope of the appended claims.

Moreover, when representative embodiments are described, the specification may have presented a method and/or a process as a particular sequence of acts. However, to an extent that the method or the process does not depend on the specific sequence of the acts described herein, the method or the process should not be limited to the acts with the specific sequence. Those of ordinary skills in the art will understand that other sequences of acts may also be possible. Therefore, the specific sequence of the acts illustrated in the specification should not be interpreted as a limitation on appended claims. Moreover, the execution of the acts in the claims for the method and/or the process should not be limited to the written sequence, and it can be easily understood by those skilled in the art that these sequences may be changed and still fall within the spirit and scope of the embodiments of the present application.

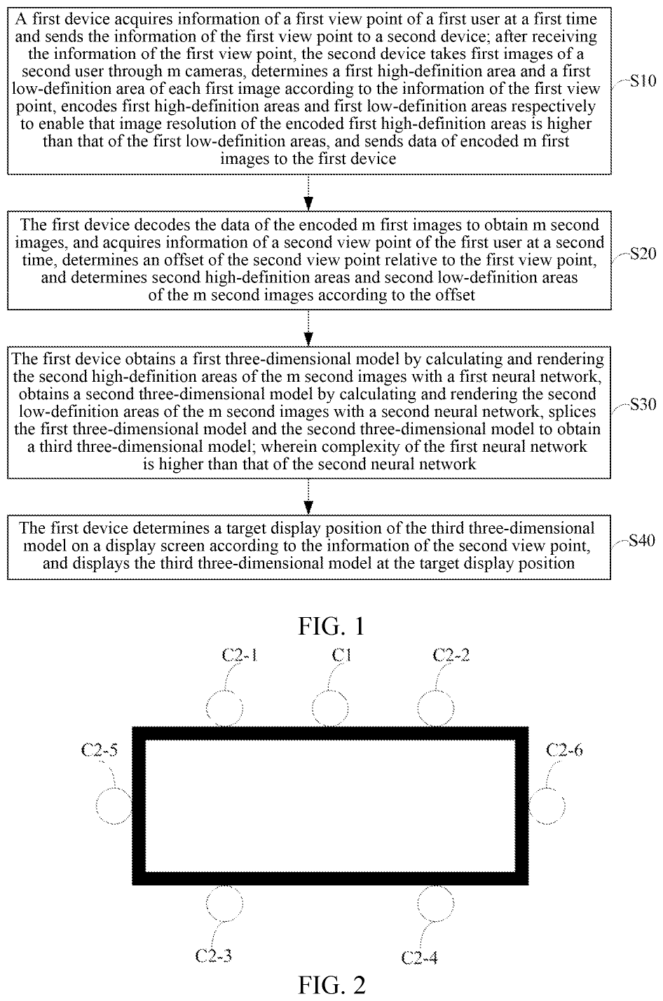

As shown in FIG. 1, an embodiment of the present application provides a video communication method based on three-dimensional display, including the following acts.

In act S10, the first device acquires information of a first view point of a first user at a first time and sends the information of the first view point to a second device; after receiving the information of the first view point, the second device takes first images of a second user through m cameras, determines a first high-definition area and a first low-definition area of each first image according to the information of the first view point, encodes first high-definition areas and first low-definition areas respectively such that image resolution of encoded first high-definition areas is higher than that of encoded first low-definition areas, sends data of encoded m first images to the first device; wherein, areas around the first view point are the first high-definition areas, and other areas than the first high-definition areas are the first low-definition areas; and m is greater than or equal to 2.

In act S20, the first device decodes the data of the encoded m first images to obtain m second images, and acquires information of a second view point of the first user at a second time, determines an offset of the second view point relative to the first view point, determines second high-definition areas and second low-definition areas of the m second images according to the offset; wherein, areas around the second view point are the second high-definition areas, and other areas than the second high-definition areas are the second low-definition areas.

In act S30, the first device obtains a first three-dimensional model by calculating and rendering the second high-definition areas of the m second images with a first neural network, obtains a second three-dimensional model by calculating and rendering the second low-definition areas of the m second images with a second neural network, and splices the first three-dimensional model and the second three-dimensional model to obtain a third three-dimensional model; wherein complexity of the first neural network is higher than that of the second neural network.

In act S40, the first device determines a target display position of the third three-dimensional model on a display screen according to the information of the second view point, and displays the third three-dimensional model at the target display position.

Herein the first device and the second device are three-dimensional display devices.

According to the video communication method based on three-dimensional display provided by the embodiment of the present application, a first device sends information of a view point of a first user to a second device, the second device determines the high-definition areas (the areas around the view point) and the low-definition areas of m first images of the second user taken by m cameras according to the received information of the view point, and encodes the high-definition areas and the low-definition areas in different coding modes such that image resolution of the encoded high-definition areas is higher than that of the encoded low-definition areas. The transmission bandwidth occupied by the encoded image can be saved by partition encoding, and since the areas around the view point are encoded in high definition, the bandwidth is saved without affecting the image definition of the areas concerned by the first user. The second device sends data of the encoded m first images to the first device, the first device decodes the data of the encoded m first images to obtain m second images, and determines an offset of the current view point (second view point) of the first user relative to the previous view point (first view point), determines the high-definition areas and the low-definition areas of the m second images according to the offset, calculates and renders the high-definition areas of the m second images with a first neural network to obtain a first three-dimensional model, calculates and renders the low-definition areas of the m second images with a second neural network to obtain a second three-dimensional model, and splices the first three-dimensional model and the second three-dimensional model to obtain a third three-dimensional model; wherein complexity of the first neural network is higher than that of the second neural network. By three-dimensional modeling of high-definition and low-definition areas using neural networks with different complexities respectively, the computational resources can be saved, and due to the use of the neural network with high complexity for the areas around the view point, the effect of three-dimensional modeling can be guaranteed. The first device determines a target display position of the third three-dimensional model on a display screen according to the information of the current view point, and displays the third three-dimensional model at the target display position. The video communication method in the present diclosure can implement real-time three-dimensional scene video communication, and save communication bandwidth and computing resources.

In some exemplary embodiments, acquiring, by the first device, the information of the first view point of the first user at the first time includes: taking, by the first device, a face image of the first user through a first camera at the first time, performing facial feature point detection on the face image, if a face is detected, performing eye recognition in a face area, marking a left eye area and a right eye area, performing left pupil recognition in the left eye area, determining a relative position of the left pupil in the left eye area, performing right pupil recognition in the right eye area, determining a relative position of the right pupil in the right eye area, determining an intersection point position of binocular lines of sight of the first user on a display screen of the first device according to the relative position of the left pupil in the left eye area and the relative position of the right pupil in the right eye area, and taking the intersection point position as the first view point of the first user at the first time.

In some exemplary embodiments as shown in FIG. 2, the first camera C1 is disposed in the middle of the top border of the display screen of the first device.

In some exemplary embodiments, video communication is conducted between the first device and the second device over a remote network.

The remote network includes a wireless communication network, a mobile communication network, a wired communication network and the like.

In some exemplary embodiments, sending, by the first device, the information of the first view point of the first user at the first time to the second device includes: the first device sends the information of the first view point of the first user at the first time to the second device over a remote communication network.

In some exemplary embodiments, after the first device takes the face image of the first user through the first camera, the method further includes:
reducing resolution of the face image.

Reducing the resolution of the face image can save computational resources, and reduce computing time.

In some exemplary embodiments, as shown in FIG. 2, the m cameras (Camera C2-1, Camera C2-2, Camera C2-3, Camera C2-4, Camera C2-5, Camera C2-6) are respectively disposed in the left and right half areas of the top border, the left and right half areas of the bottom border, the middle area of the left border and the middle area of the right border of the display screen of the second device. That is, six cameras are symmetrically distributed on the four borders of the display screen.

In some exemplary embodiments, encoding the first high-definition areas and the first low-definition areas to enable image resolution of the encoded first high-definition areas is higher than that of the encoded first low-definition areas, includes:
keeping a number of pixels in the first high definition areas unchanged; and
compressing laterally a number of pixels in the first low definition areas to 1/N of the original number of pixels in the first low definition areas, or compressing vertically the number of pixels in the first low definition areas to 1/N of the original number of pixels in the first low definition areas; wherein N is greater than or equal to 2.

In some exemplary embodiments, compressing laterally the number of pixels in the first low definition areas to 1/N of the original number of pixels in the first low definition areas includes:
every N columns of pixels are compressed into a new column of pixels by starting from a first column of pixels in the first low definition areas, wherein pixel values of the new column of pixels are average values or weighted average values of pixel values of the N columns of pixels.

In some exemplary embodiments, compressing vertically the number of pixels in the first low definition areas to 1/N of the original number of pixels in the first low definition areas includes:
every N rows of pixels are compressed into a new row of pixels by starting from a first row of pixels in the first low definition areas, wherein pixel values of the new row of pixels are average values or weighted average values of pixel values of the N rows of pixels.

In some exemplary embodiments, the view point is an intersection point of binocular lines of sight of a user on the display screen.

In some exemplary embodiments, acquiring, by the first device, information of the second view point of the first user at the second time includes:
taking, by the first device, the face image of the first user through the first camera at the second time, performing facial feature point detection on the face image, if the face is detected, performing eye recognition in the face area, marking the left eye area and the right eye area, performing left pupil recognition in the left eye area, determining a relative position of the left pupil in the left eye area, performing right pupil recognition in the right eye area, determining a relative position of the right pupil in the right eye area, determining an intersection point position of binocular lines of sight of the first user on the display screen of the first device according to the relative position of the left pupil in the left eye area and the relative position of the right pupil in the right eye area, and taking the intersection point position as the second view point of the first user at the second time.

In some exemplary embodiments, decoding, by the first device, the data of the encoded m first images to obtain m second images includes:
for data of any one of the encoded first images, decoding a first high-definition area and a first low-definition area of the first image and decompressing the low-definition area of the first image, to obtain a second image.

In some exemplary embodiments, as shown in FIG. 3, determining, by the first device, the second high-definition areas and the second low-definition areas of the m second images according to the offset includes:
for any one of the second images, marking a same area on the second image as a high-definition reference area according to the position of the first high-definition area of a first image for generating the second image, and marking a same area on the second image as a low-definition reference area according to a position of a first low-definition area of the first image for generating the second image;
translating the high-definition reference area according to the offset to obtain a second high-definition area, and translating the low-definition reference area according to the offset to obtain a second low-definition area;
keeping pixels in an area where the high-definition reference area and the second high-definition area overlap unchanged;
processing pixels in a pixel area to be processed, belonging to the second high-definition area, in the low-definition reference area as follows:
for any target pixel row of a first pixel row to a c-th pixel row, which are pixel rows from top to bottom in the pixel area to be processed, performing the following processing: drawing pixel values of a columns of pixels in the high-definition reference area, that are located in a same row with the target pixel row, and pixel values of a columns of pixels included in the target pixel row on a coordinate axis to generate a first curve, performing smoothing processing on the first curve, and replacing original pixel values on the target pixel row with new pixel values corresponding to the target pixel row on the smoothed first curve; wherein a is a number of pixels included by the offset in a lateral direction; c is a lowermost row in an area where the high-definition reference area and the second high-definition area overlap;
for any target pixel column of a first pixel column to a d-th pixel column, which are pixel columns from left to right in the pixel area to be processed, performing the following processing: drawing pixel values of b rows of pixels in the high definition reference area, that are located in a same column with the target pixel column, and pixel values of b rows of pixels included in the target pixel column on a coordinate axis to generate a second curve, performing smoothing processing on the second curve, and replacing original pixel values on the target pixel column with new pixel values corresponding to the target pixel column on the smoothed second curve; wherein b is a number of pixels included by the offset in a longitudinal direction; d is a rightmost column in the area where the high-definition reference area and the second high-definition area overlap.

In some exemplary embodiments, the smoothing processing includes Cubic-Bezier fitting.

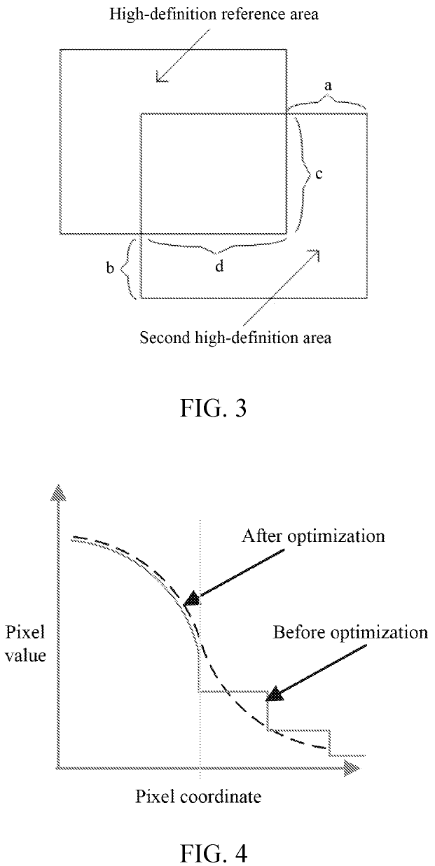

FIG. 4 is a schematic diagram of smoothing (optimization) of a first curve (a second curve). Before optimization, the right area on the first curve (second curve) corresponds to the original pixel values of the target pixel row (column), and the pixel values among different pixels are quite different. After optimization, the right area on the first curve (second curve) corresponds to the new pixel values of the target pixel row (column), and the pixel value difference among different pixels becomes smaller.

In some exemplary embodiments, the first neural network is a deep neural network, and the second neural network is a shallow neural network.

In some exemplary embodiments, determining, by the first device, the target display position of the third three-dimensional model on the display screen according to the information of the second view point, displaying the third three-dimensional model at the target display position, includes:
according to the information of the second view point, the first device using left and right virtual cameras to take images of the third three-dimensional model to obtain a left-eye image and a right-eye image, and combining the left-eye image and the right-eye image to generate a target picture of the third three-dimensional model, wherein the left-eye image is on a left side of the second view point in the target picture, and the right-eye image is on a right side of the second view point in the target picture; and
displaying the target picture on the display screen of the first device.

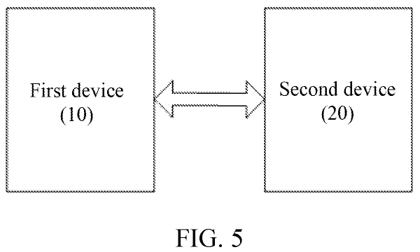

As shown in FIG. 5, an embodiment of the present application provides a video communication system based on three-dimensional display, including a first device 10 and a second device 20.

The first device 10 is configured to acquire information of a first view point of a first user at a first time and send the information of the first view point to a second device, receiving data of encoded m first images sent by the second device, decode the data of the encoded m first images to obtain m second images, acquire information of a second view point of the first user at a second time, determine an offset of the second view point relative to the first view point, and determine second high-definition areas and second low-definition areas of the m second images according to the offset; wherein, areas around the second view point are the second high-definition areas, and other areas than the second high-definition areas are the second low-definition areas; obtain a first three-dimensional model by calculating and rendering the second high-definition areas of the m second images with a first neural network, obtain a second three-dimensional model by calculating and rendering the second low-definition areas of the m second images with a second neural network, obtain a third three-dimensional model by splicing the first three-dimensional model and the second three-dimensional model; wherein complexity of the first neural network is higher than that of the second neural network, determine a target display position of the third three-dimensional model on a display screen according to the information of the second view point, and display the third three-dimensional model at the target display position.

The second device 20 is configured to take first images of a second user through m cameras after receiving the information of the first view point, determine a first high-definition area and a first low-definition area of each first image according to the information of the first view point, encode first high-definition areas and first low-definition areas respectively to enable an image resolution of encoded first high-definition areas is higher than that of the encoded first low-definition areas, and send data of encoded m first images to the first device; wherein, areas around the first view point are first high-definition areas, and other areas than the first high-definition areas are first low-definition areas; and m is greater than or equal to 2.

Herein the first device and the second device are three-dimensional display devices.

According to the video communication system based on three-dimensional display provided by the embodiment of the present application, a first device sends information of a view point of a first user to a second device, and the second device determines high-definition areas (areas around the view point) and low-definition areas of m first images of the second user taken by m cameras according to the received information of the view point, encodes the high-definition areas and the low-definition areas in different coding modes such that image resolution of the encoded high-definition areas is higher than that of the encoded low-definition areas. The transmission bandwidth occupied by the encoded images can be saved by partition encoding, and since the areas around the view point are encoded in high definition, the bandwidth is saved without affecting the image definition of the areas concerned by the first user. The second device sends data of the encoded m first images to the first device, the first device decodes the data of the encoded m first images to obtain m second images, and determines an offset of the current view point (second view point) of the first user relative to the previous view point (first view point), determines the high-definition areas and the low-definition areas of the m second images according to the offset, calculates and renders the high-definition areas of the m second images with a first neural network to obtain a first three-dimensional model, calculates and renders the low-definition areas of the m second images with a second neural network to obtain a second three-dimensional model, and splices the first three-dimensional model and the second three-dimensional model to obtain a third three-dimensional model; wherein complexity of the first neural network is higher than that of the second neural network. By three-dimensional modeling of high-definition and low-definition areas using neural networks with different complexities respectively, the computational resources can be saved, and due to the use of the neural network with high complexity for the areas around the view point, the effect of three-dimensional modeling can be guaranteed. The first device determines a target display position of the third three-dimensional model on a display screen according to the information of the current view point, and displays the third three-dimensional model at the target display position. The video communication system in the present application can implement real-time three-dimensional scene video communication, and save communication bandwidth and computational resources.

In some exemplary embodiments, the first device is configured to acquire the information of the first view point of the first user at the first time by the following:
taking a face image of the first user at the first time through a first camera, performing facial feature point detection on the face image, if a face is detected, performing eye recognition in a face area, marking a left eye area and a right eye area, performing left pupil recognition in the left eye area, determining a relative position of the left pupil in the left eye area, performing right pupil recognition in the right eye area, determining a relative position of the right pupil in the right eye area, determining an intersection point position of binocular lines of sight of the first user on the display screen of the first device according to the relative position of the left pupil in the left eye area and the relative position of the right pupil in the right eye area, and taking the intersection point position as the first view point of the first user at the first time.

In some exemplary embodiments, the first camera C1 is disposed in the middle of the top border of the display screen of the first device.

In some exemplary embodiments, video communication is conducted between the first device and the second device over a remote network.

In some exemplary embodiments, the first device is configured to send the information of the first view point of the first user at the first time to the second device by the following: the first device sends the information of the first view point of the first user at the first time to the second device over a remote communication network.

In some exemplary embodiments, the first device is further configured to reduce resolution of the face image of the first user after taking the face image of the first user through a first camera.

Reducing the resolution of the face image can save computational resources and reduce computing time.

In some exemplary embodiments, as shown in FIG. 2, the m cameras (Camera C2-1, Camera C2-2, Camera C2-3, Camera C2-4, Camera C2-5, Camera C2-6) are respectively disposed in the left and right half areas of the top border, the left and right half areas of the bottom border, the middle area of the left border and the middle area of the right border of the display screen of the second device. That is, six cameras are symmetrically distributed on the four borders of the display screen.

In some exemplary embodiments, the first device is configured to encode the first high-definition areas and the first low-definition areas respectively to enable the image resolution of the encoded first high-definition areas is higher than that of the encoded first low-definition areas by the following:
keeping a number of pixels in the first high definition areas unchanged; and
compressing laterally a number of pixels in the first low definition areas to 1/N of the original number of pixels in the first low definition areas, or compressing vertically the number of pixels in the first low definition areas to 1/N of the original number of pixels in the first low definition areas; wherein N is greater than or equal to 2.

In some exemplary embodiments, compressing laterally the number of pixels in the first low definition areas to 1/N of the original number of pixels in the first low definition areas includes:
every N columns of pixels are compressed into a new column of pixels by starting from a first column of pixels in the first low definition areas, wherein pixel values of the new column of pixels are average values or weighted average values of pixel values of the N columns of pixels.

In some exemplary embodiments, compressing vertically the number of pixels in the first low definition areas to 1/N of the original number of pixels in the first low definition areas includes:
every N rows of pixels are compressed into a new row of pixels by starting from a first row of pixels in the first low definition areas, wherein pixel values of the new row of pixels are average values or weighted average values of pixel values of the N rows of pixels.

In some exemplary embodiments, the first device is configured to acquire the information of the second view point of the first user at the second time by the following:
taking a face image of the first user through the first camera at the second time, performing facial feature point detection on the face image, if the face is detected, performing eye recognition in the face area, marking the left eye area and the right eye area, performing left pupil recognition in the left eye area, determining a relative position of the left pupil in the left eye area, performing right pupil recognition in the right eye area, determining a relative position of the right pupil in the right eye area, determining an intersection point position of binocular lines of sight of the first user on the display screen of the first device according to the relative position of the left pupil in the left eye area and the relative position of the right pupil in the right eye area, and taking the intersection point position as the second view point of the first user at the second time.

In some exemplary embodiments, the first device is configured to decode the data of the encoded m first images to obtain m second images by the following:
for data of any one of the encoded first images, decoding a first high-definition area and a first low-definition area of the first image and decompressing the low-definition area of the first image, to obtain a second image.

In some exemplary embodiments, a first device is configured to determine the second high-definition areas and the second low-definition areas of the m second images according to the offset by the following:
for any one of the second images, marking a same area on the second image as a high-definition reference area according to the position of the first high-definition area of a first image for generating the second image, and marking a same area on the second image as a low-definition reference area according to a position of a first low-definition area of the first image for generating the second image;
translating the high-definition reference area according to the offset to obtain a second high-definition area, and translating the low-definition reference area according to the offset to obtain a second low-definition area;
keeping pixels in an area where the high-definition reference area and the second high-definition area overlap unchanged;
processing pixels in a pixel area to be processed, belonging to the second high-definition area, in the low-definition reference area as follows:
for any target pixel row of a first pixel row to a c-th pixel row, which are pixel rows from top to bottom in the pixel area to be processed, performing the following processing: drawing pixel values of a columns of pixels in the high-definition reference area, that are located in a same row with the target pixel row, and pixel values of a columns of pixels included in the target pixel row on a coordinate axis to generate a first curve, performing smoothing processing on the first curve, and replacing original pixel values on the target pixel row with new pixel values corresponding to the target pixel row on the smoothed first curve; wherein a is a number of pixels included by the offset in a lateral direction; c is a lowermost row in an area where the high-definition reference area and the second high-definition area overlap;
for any target pixel column of a first pixel column to a d-th pixel column, which are pixel columns from left to right in the pixel area to be processed, performing the following processing: drawing pixel values of b rows of pixels in the high definition reference area, that are located in a same column with the target pixel column, and pixel values of b rows of pixels included in the target pixel column on a coordinate axis to generate a second curve, performing smoothing processing on the second curve, and replacing original pixel values on the target pixel column with new pixel values corresponding to the target pixel column on the smoothed second curve; wherein b is a number of pixels included by the offset in a longitudinal direction; d is a rightmost column in the area where the high-definition reference area and the second high-definition area overlap.

In some exemplary embodiments, the smoothing processing includes Cubic-Bezier fitting.

In some exemplary embodiments, the first neural network is a deep neural network, and the second neural network is a shallow neural network.

In some exemplary embodiments, the first device is configured to determine the target display position of the third three-dimensional model on the display screen according to the information of the second view point, and display the third three-dimensional model at the target display position, by the following:
according to the information of the second view point, using left and right virtual cameras to take images of the third three-dimensional model to obtain a left-eye image and a right-eye image, and combining the left-eye image and the right-eye image to generate a target picture of the third three-dimensional model, wherein the left-eye image is on a left side of the second view point in the target picture and the right-eye image is on a right side of the second view point in the target picture; and
displaying the target picture on the display screen of the first device.

Those of ordinary skills in the art may understand that all or some of acts in the methods, systems, functional modules or units in apparatuses disclosed above may be implemented as software, firmware, hardware, and an appropriate combination thereof. In a hardware implementation, division of the function modules/units mentioned in the above description does not always correspond to division of physical components. For example, a physical component may have multiple functions, or a function or an act may be executed by several physical components in cooperation. Some components or all components may be implemented as software executed by a processor such as a digital signal processor or a microprocessor, or implemented as hardware, or implemented as an integrated circuit such as a specific integrated circuit. Such software may be distributed on a computer-readable medium, and the computer-readable medium may include a computer storage medium (or a non-transitory medium) and a communication medium (or a transitory medium). As known to those of ordinary skills in the art, a term computer storage medium includes volatile or nonvolatile, and removable or irremovable media implemented in any method or technology for storing information (for example, a computer-readable instruction, a data structure, a program module, or other data). The computer storage medium includes, but is not limited to, an RAM, an ROM, an EEPROM, a flash memory or another memory technology, a CD-ROM, a Digital Versatile Disk (DVD) or another optical disk storage, a magnetic cartridge, a magnetic tape, magnetic disk storage or another magnetic storage apparatus, or any other medium that may be configured to store desired information and may be accessed by a computer. In addition, it is known to those of ordinary skills in the art that the communication medium usually includes a computer-readable instruction, a data structure, a program module, or other data in a modulated data signal of, such as, a carrier or another transmission mechanism, and may include any information delivery medium.

1. A video communication method based on three-dimensional display, comprising:
acquiring, by a first device, information of a first view point of a first user at a first time and sending the information of the first view point to a second device; after receiving the information of the first view point, taking, by the second device, first images of a second user through m cameras, determining a first high-definition area and a first low-definition area of each first image according to the information of the first view point, encoding first high-definition areas and first low-definition areas respectively to enable image resolution of the encoded first high-definition areas is higher than that of the encoded first low-definition areas, and sending data of encoded m first images to the first device; wherein, areas around the first view point are the first high-definition areas, and other areas than the first high-definition area are the first low-definition areas; and m is greater than or equal to 2;
decoding, by the first device, the data of the encoded m first images to obtain m second images, and acquiring information of a second view point of the first user at a second time, determining an offset of the second view point relative to the first view point, and determining second high-definition areas and second low-definition areas of the m second images according to the offset; wherein, areas around the second view point are the second high-definition areas, and other areas than the second high-definition areas are the second low-definition areas;
obtaining, by the first device, a first three-dimensional model by calculating and rendering the second high-definition areas of the m second images with a first neural network, obtaining a second three-dimensional model by calculating and rendering the second low-definition areas of the m second images with a second neural network, splicing the first three-dimensional model and the second three-dimensional model to obtain a third three-dimensional model; wherein complexity of the first neural network is higher than that of the second neural network; and
determining, by the first device, a target display position of the third three-dimensional model on a display screen according to the information of the second view point, and displaying the third three-dimensional model at the target display position;
wherein the first device and the second device are three-dimensional display devices.

2. The method according to claim 1, wherein,
acquiring, by the first device, the information of the first view point of the first user at the first time comprises:
taking, by the first device, a face image of the first user at the first time through a first camera, performing facial feature point detection on the face image, if detecting a face, performing eye recognition in a face area, and marking a left eye area and a right eye area, performing left pupil recognition in the left eye area, determining a relative position of the left pupil in the left eye area, performing right pupil recognition in the right eye area, determining a relative position of the right pupil in the right eye area, determining an intersection point position of binocular lines of sight of the first user on the display screen of the first device according to the relative position of the left pupil in the left eye area and the relative position of the right pupil in the right eye area, and taking the intersection point position as the first view point of the first user at the first time;
acquiring, by the first device, the information of the second view point of the first user at the second time comprises:
taking, by the first device, a face image of the first user at the second time through the first camera, performing facial feature point detection on the face image, if detecting a face, performing eye recognition in a face area, and marking a left eye area and a right eye area, performing left pupil recognition in the left eye area, determining a relative position of the left pupil in the left eye area, performing right pupil recognition in the right eye area, determining a relative position of the right pupil in the right eye area, determining an intersection point position of binocular lines of sight of the first user on the display screen of the first device according to the relative position of the left pupil in the left eye area and the relative position of the right pupil in the right eye area, and taking the intersection point position as the second view point of the first user at the second time.

3. The method according to claim 1, wherein, video communication is conducted between the first device and the second device over a remote network.

4. The method according to claim 1, wherein,
encoding the first high-definition areas and the first low-definition areas respectively to enable that the image resolution of the encoded first high-definition areas is higher than that of the encoded first low-definition areas comprises:
keeping a number of pixels in the first high definition areas unchanged;
compressing laterally a number of pixels in the first low definition areas to 1/N of the original number of pixels in the first low definition areas, or compressing vertically a number of pixels in the first low definition areas to 1/N of the original number of pixels in the first low definition areas; wherein N is greater than or equal to 2.

5. The method according to claim 4, wherein:
compressing laterally the number of pixels in the first low definition areas to 1/N of the original number of pixels in the first low definition areas comprises:
compressing every N columns of pixels into a new column of pixels by starting from a first column of pixels in the first low definition areas,, wherein pixel values of the new column of pixels are average values or weighted average values of pixel values of the N columns of pixels;
compressing vertically the number of pixels in the first low definition areas to 1/N of the original number of pixels in the first low definition areas comprises:
compressing every N rows of pixels into a new row of pixels by starting from a first row of pixels in the first low definition areas, wherein pixel values of the new row of pixels are average values or weighted average values of pixel values of the N rows of pixels.

6. The method according to claim 4, wherein,
decoding, by the first device, the data of the encoded m first images to obtain the m second images comprises:
for data of any one of the encoded first images, decoding a first high-definition area and a first low-definition area of the first image and decompressing the low-definition area of the first image, to obtain a second image.

7. The method according to claim 1, wherein,
determining, by the first device, the second high-definition areas and the second low-definition areas of the m second images according to the offset comprises:
for any one of the second images, marking a same area on the second image as a high-definition reference area according to a position of a first high-definition area of a first image for generating the second image, marking a same area on the second image as a low-definition reference area according to a position of a first low-definition area of the first image for generating the second image;
translating the high-definition reference area according to the offset to obtain a second high-definition area, translating the low-definition reference area according to the offset to obtain a second low-definition area;
keeping pixels in an area where the high-definition reference area and the second high-definition area overlap unchanged;
processing pixels in a pixel area to be processed, belonging to the second high-definition area, in the low-definition reference area as follows:
for any target pixel row of a first pixel row to a c-th pixel row, which are pixel rows from top to bottom in the pixel area to be processed, performing the following processing: drawing pixel values of a columns of pixels in the high-definition reference area, that are located in a same row with the target pixel row, and pixel values of a columns of pixels included in the target pixel row on a coordinate axis to generate a first curve, performing smoothing processing on the first curve, replacing original pixel values on the target pixel row with new pixel values corresponding to the target pixel row on the smoothed first curve; wherein a is a number of pixels included by the offset in a lateral direction; c is a lowermost row in the area where the high-definition reference area and the second high-definition area overlap;
for any target pixel column of a first pixel column to a d-th pixel column, which are pixel column from left to right in the pixel area to be processed, performing the following processing: drawing pixel values of b rows of pixels in the high definition reference area, that are located in a same column with the target pixel column, and pixel values of b rows of pixels included in the target pixel column on a coordinate axis to generate a second curve, performing smoothing processing on the second curve, and replacing original pixel values on the target pixel column with new pixel values corresponding to the target pixel column on the smoothed second curve; wherein b is a number of pixels included by the offset in a longitudinal direction; d is a rightmost column in the area where the high-definition reference area and the second high-definition area overlap.

8. The method according to claim 1, wherein,
determining, by the first device, the target display position of the third three-dimensional model on the display screen according to the information of the second view point, and displaying the third three-dimensional model at the target display position, comprises:
according to the information of the second view point, using both left and right virtual cameras to take images of the third three-dimensional model to obtain a left-eye image and a right-eye image, combining the left-eye image and the right-eye image to generate a target picture of the third three-dimensional model, wherein the left-eye image is on a left side of the second view point in the target picture, the right-eye image is on a right side of the second view point in the target picture; and
displaying the target picture on the display screen of the first device.

9. A video communication system based on three-dimensional display, comprising:
a first device, configured to acquire information of a first view point of a first user at a first time and send the information of the first view point to a second device, receive data of encoded m first images sent by the second device, decode the data of the encoded m first images to obtain m second images, and acquire information of a second view point of the first user at a second time, determine an offset of the second view point relative to the first view point, determine second high-definition areas and second low-definition areas of the m second images according to the offset; wherein, areas around the second view point are the second high-definition areas, and other areas than the second high-definition areas are the second low-definition areas; obtain a first three-dimensional model by calculating and rendering the second high-definition areas of the m second images with a first neural network, obtain a second three-dimensional model by calculating and rendering the second low-definition areas of the m second images with a second neural network, obtain a third three-dimensional model by splicing the first three-dimensional model and the second three-dimensional model, wherein complexity of the first neural network is higher than that of the second neural network;
determine a target display position of the third three-dimensional model on a display screen according to the information of the second view point, and display the third three-dimensional model at the target display position;
the second device, configured to take first images of a second user through m cameras after receiving the information of the first view point; determine a first high-definition area and a first low-definition area of each first image according to the information of the first view point; encode the first high-definition areas and the first low-definition areas respectively to enable image resolution of the encoded first high-definition areas is higher than that of the first low-definition areas; send the data of the encoded m first images to the first device; wherein, areas around the first view point are the first high-definition areas, and other areas than the first high-definition areas are the first low-definition areas; and m is greater than or equal to 2;
wherein the first device and the second device are three-dimensional display devices.

10. The system according to claim 9, wherein,
the first device is configured to acquire the information of the first view point of the first user at the first time by the following:
taking a face image of the first user at the first time through a first camera, performing facial feature point detection on the face image, if a face is detected, performing eye recognition in a face area, and marking a left eye area and a right eye area, performing left pupil recognition in the left eye area, determining a relative position of the left pupil in the left eye area, performing right pupil recognition in the right eye area, determining a relative position of the right pupil in the right eye area, determining an intersection point position of binocular lines of sight of the first user on the display screen of the first device according to the relative position of the left pupil in the left eye area and the relative position of the right pupil in the right eye area, and taking the intersection point position as the first view point of the first user at the first time;
the first device is configured to acquire the information of the second view point of the first user at the second time by the following:
taking a face image of the first user at the second time through the first camera, performing facial feature point detection on the face image, if a face is detected, performing eye recognition in the face area, and marking a left eye area and a right eye area, performing left pupil recognition in the left eye area, determining a relative position of the left pupil in the left eye area, performing right pupil recognition in the right eye area, determining a relative position of the right pupil in the right eye area, determining an intersection point position of binocular lines of sight of the first user on the display screen of the first device according to the relative position of the left pupil in the left eye area and the relative position of the right pupil in the right eye area, and taking the intersection point position as the second view point of the first user at the second time.

11. The system according to claim 9, wherein,
the first device is configured to encode the first high-definition areas and the first low-definition areas respectively to enable the image resolution of the encoded first high-definition areas is higher than that of the encoded first low-definition areas by the following:
keeping a number of pixels in the first high definition areas unchanged;
compressing laterally a number of pixels in the first low definition areas to 1/N of the original number of pixels in the first low definition areas, or compressing vertically a number of pixels in the first low definition areas to 1/N of the original number of pixels vertically; wherein N is greater than or equal to 2.

12. The system according to claim 11, wherein,
the first device is configured to decode the data of the encoded m first images to obtain the m second images by the following:
for data of any one of the encoded first images, decoding a first high-definition area and a first low-definition area of the first image and decompressing the low-definition area of the first image, to obtain a second image.

13. The system according to claim 9, wherein,
the first device is configured to determine the second high-definition areas and the second low-definition areas of the m second images according to the offset comprises by the following:
for any one of the second images, marking a same area on the second image as a high-definition reference area according to a position of a first high-definition area of a first image for generating the second image, marking a same area on the second image as a low-definition reference area according to a position of a first low-definition area of the first image for generating the second image;
translating the high-definition reference area according to the offset to obtain a second high-definition area, translating the low-definition reference area according to the offset to obtain a second low-definition area;
keeping pixels in an area where the high-definition reference area and the second high-definition area overlap unchanged;
processing pixels in a pixel area to be processed, belonging to the second high-definition area, in the low-definition reference area as follows:
for any target pixel row of a first pixel row to a c-th pixel row, which are pixel rows from top to bottom in the pixel area to be processed, performing the following processing: drawing pixel values of a columns of pixels in the high-definition reference area that are located in a same row with the target pixel row, and pixel values of a columns of pixels included in the target pixel row on a coordinate axis to generate a first curve, performing smoothing processing on the first curve, replacing original pixel values on the target pixel row with new pixel values corresponding to the target pixel row on the smoothed first curve; wherein a is a number of pixels included by the offset in a lateral direction; c is a lowermost row in the area where the high-definition reference area and the second high-definition area overlap;
for any target pixel column of a first pixel column to a d-th pixel column, which are pixel column from left to right in the pixel area to be processed, performing the following processing: drawing pixel values of b rows of pixels in the high definition reference area, that are located in a same column with the target pixel column, and pixel values of b rows of pixels included in the target pixel column on a coordinate axis to generate a second curve, performing smoothing processing on the second curve, and replacing original pixel values on the target pixel column with new pixel values corresponding to the target pixel column on the smoothed second curve; wherein b is a number of pixels included by the offset in a longitudinal direction; d is a rightmost column in the area where the high-definition reference area and the second high-definition area overlap.

14. The system according to claim 9, wherein,
the first device is configured to determine the target display position of the third three-dimensional model on the display screen according to the information of the second view point, and display the third three-dimensional model at the target display position, by the following:
according to the information of the second view point, using both left and right virtual cameras to take images of the third three-dimensional model to obtain a left-eye image and a right-eye image, combining the left-eye image and the right-eye image to generate a target picture of the third three-dimensional model, wherein the left-eye image is on a left side of the second view point in the target picture, the right-eye image is on a right side of the second view point in the target picture; and
displaying the target picture on the display screen of the first device.

15. The system according to claim 9, wherein,
the first camera is disposed in the middle of a top border of the display screen of the first device; and
the m cameras are respectively disposed in left and right half areas of a top border, left and right half areas of a bottom border, a middle area of the left border and a middle area of the right border of a display screen of the second device.

16. The method according to claim 1, wherein,
the first camera is disposed in the middle of a top border of the display screen of the first device; and
the m cameras are respectively disposed in left and right half areas of a top border, left and right half areas of a bottom border, a middle area of the left border and a middle area of the right border of a display screen of the second device.

17. The method according to claim 2, wherein after the first device takes the face image of the first user through the first camera, the method further comprises:
reducing resolution of the face image.

18. The method according to claim 7, wherein the smoothing processing includes Cubic-Bezier fitting.

19. The system according to claim 10, wherein the first device is further configured to reduce resolution of the face image after taking the face image of the first user through the first camera.

20. The system according to claim 13, wherein the smoothing processing includes Cubic-Bezier fitting.
